(19) United States
(12) Patent Application Publication
(10) Pub. No.: US 2026/0352607 A1
(43) Pub. Date: Nov. 5, 2026

(54) TECHNOLOGIES FOR LAYER-2 CUMULATIVE MODE AND PACKET FORWARDING

(71) Applicant: Apple Inc., Cupertino, CA (US)

(72) Inventors: Ralf Rossbach, Munich (DE); Fangli Xu, Beijing (CN); Sudeep Manithara Vamanan, Nuremberg (DE); Naveen Kumar R. Palle Venkata, San Diego, CA (US); Zhibin Wu, Los Altos, CA (US); Ping-Heng Kuo, London (GB); Peng Cheng, Beijing (CN); Sethuraman Gurumoorthy, San Ramon, CA (US); Dawei Zhang, Saratoga, CA (US); Alexander Sirotkin, Tel Aviv (IL); Haijing Hu, Los Gatos, CA (US); Yuqin Chen, Beijing (CN)

(73) Assignee: Apple Inc., Cupertino, CA (US)

(21) Appl. No.: 19/488,558

(22) PCT Filed: May 30, 2023
(86) PCT No.: PCT/CN2023/097240

§ 371 Date: Nov. 26, 2025

(51) Int. Cl. H04L 47/31; H04L 47/32; H04L 47/34; H04W 28/02

(52) U.S. Cl. CPC H04L 47/31; H04L 47/32; H04L 47/34; H04W 28/0268

(57) ABSTRACT

The present application relates to devices and components, including apparatus, systems, and methods for filtering, buffering, discarding, and forwarding cumulative packets.

### TECHNICAL FIELD

This application generally relates to cellular communication networks and, in particular, to technologies for transmitting or forwarding cumulative packets.

### BACKGROUND

When a receiver successfully decodes a data packet, it may send an acknowledgment (Ack) packet to the sender to indicate the successful reception of the corresponding data packet. Some applications, such as transmission control protocol (TCP) may be configured with cumulative Ack. A cumulative Ack packet may indicate successful reception of all data packets until the data packet that corresponds to the Ack packet. Cumulative Acks carry redundant information, and optimizing the operation of cumulative Ack transmissions may be beneficial.

### BRIEF DESCRIPTION OF THE DRAWINGS

FIG. 1 illustrates a network environment in accordance with some embodiments

FIG. 2 illustrates a network environment in accordance with some embodiments

FIG. 3 illustrates a network environment in accordance with some embodiments

FIG. 4 illustrates an information element in accordance with some embodiments

FIG. 5 illustrates an information element in accordance with some embodiments

FIG. 6 illustrates a system block diagram in accordance with some embodiments

FIG. 7 illustrates a system block diagram in accordance with some embodiments

FIG. 8 illustrates a block diagram of layer operations in various network entities in accordance with some embodiments

FIG. 9 illustrates an operational flow/algorithmic structure in accordance with some embodiments

FIG. 10 illustrates an operational flow/algorithmic structure in accordance with some embodiments

FIG. 11 illustrates an operational flow/algorithmic structure in accordance with some embodiments

FIG. 12 illustrates an end-to-end block diagram implementing a per-flow CM or LIFO processing in accordance with some embodiments

FIG. 13 illustrates an end-to-end block diagram implementing a per-flow CM or LIFO processing in accordance with some embodiments

FIG. 14 illustrates a user equipment in accordance with some embodiments

FIG. 15 illustrates a network node in accordance with some embodiments

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

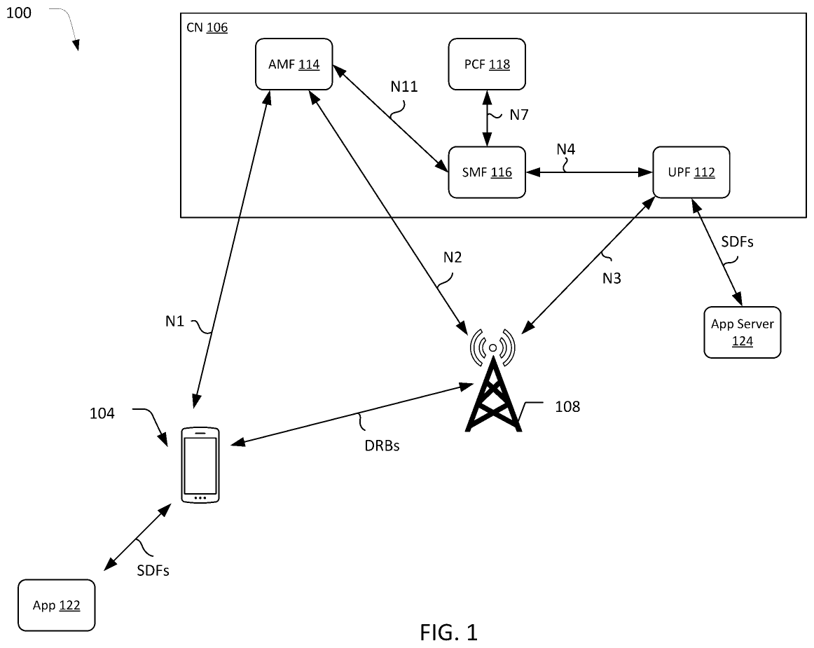

FIG. 1 illustrates a network environment 100 in accordance with some embodiments. The network environment 100 may include a core network (CN) 106. For example, the CN 106 may include an access and mobility management function (AMF) 114, a session management function (SMF), a user plane function (UPF) 112, or a policy control function (PCF) 118. In some embodiments, the UE 104 may be coupled to the CN 106 through a base station (BS) 108.

In some embodiments, the BS 108 is a next-generation node B (gNB) that provides one or more 3GPP New Radio (NR) cells. In other embodiments, the BS 108 is an evolved node B (eNB) that provides one or more Long Term Evolution (LTE) cells. The air interface over which the UE 104 and the BS 108 communicate may be compatible with 3GPP technical specifications (TSs), such as those that define Fifth Generation (5G) NR or later system standards (e.g., Sixth Generation (6G) standards).

The AMF 114 may provide services to other network functions. The AMF 114 may be responsible for handling the connection and mobility management tasks of the UE 104. For example, AMF 114 may communicate with the UE 104 at initial registration or manage handovers between different cells. The AMF 114 may handle control and non-access stratum (NAS) messages from the UE over the N1 interface. The N1 interface may be a transparent interface. A transparent interface may refer to an interface used to transfer information between two entities without modifying or processing the information.

The AMF 114 and the BS 108 may exchange control information over an N2 interface. For example, the N2 interface may be used for connection management, UE context and protocol data unit (PDU) session management, and UE mobility management.

The session management function (SMF) 116 may be responsible for interaction with the creating, updating, and removing PDUs and managing session context with the user plane function (UPF) 112. The SMF 116 and UPF 112 may exchange messages through an N4 interface. The UPF 112 may identify and transport user plane traffic information and flow based on session management data received from SMF via the N4 interface.

The SMF 116 and the AMF 114 may exchange messages through an N11 interface. The AMF 114 may forward session management requirements over the N11 interface to the SMF 116. The SMF 116 may interact with AMF via the N11 interface to establish, coordinate, and terminate PDU sessions.

Policy and charging control (PCC) is a framework used to control the flow of data and to apply charging and billing policies. The PCF 118 may implement PCC rules. The PCF 118 may send policy attributes in the PCC rules to SMF 116 over an N7 interface.

The UPF 112 may perform packet routing and forwarding, packet inspection, quality of service (QoS) handling, and external PDU sessions for interconnecting with the data network (DN). The UPF 112 and SMF 116 may exchange messages over an N4 interface. The UPF 112 may identify user plane traffic flow based on information received from the SMF 116 over the N4 interface.

In some embodiments, the network environment 100 may send information in an uplink direction. The application (App) 122 may generate data addressed to an application server 124 or other entities in the data network, e.g., another UE. The App 122 may organize and group its uplink data into one or more service data flows (SDFs). The protocol stack, e.g., the 3GPP protocol stack, in the UE 104 may receive the SDFs from the App 122. The UE 104 may establish one or more radio bearers, e.g., data radio bearers (DRBs), with the BS 108. The UE 104 may regroup the data in packets, QoS flows, and transport blocks and transmit the data to the BS 108 over the DRBs. The BS 108 may establish QoS flows, sessions, and protocol tunnels with the UPF 112 and forward the uplink data to the UPF 112. The UPF 112 may regroup the data into the SDFs and forward the SDFs to the App server 124 or the targeted destination.

Similarly, in some embodiments, the network environment 100 may send information in a downlink direction. For example, the App server 124 or other entities may have data for the App 122. The App server 124 may organize and group the downlink data into one or more SDFs and send the SDFs to the UPF 112. The UPF 112 may regroup the SDFs' data, assign them to sessions or QoS flows, and send them to the BS 108. The BS 108 protocol stack may regroup the data into transport blocks and send the transport blocks to the UE 104 via DRBs. The UE 104 may regroup the transport blocks into the SDFs and deliver the SDFs to the destination, App 122.

Consider that a transmitting (Tx) entity sends a packet to a receiving (Rx) entity. In some instances, the Rx entity may send a message to the Tx entity to inform the Tx entity of the status of the reception of the packet at the Rx entity. For example, the Rx entity may send an acknowledgment (Ack) message to the Tx entity to indicate the successful reception of the packet. Alternatively, the Rx may send a negative acknowledgment (Nack) to indicate unsuccessful reception of the packet by the Rx entity. The Tx and Rx entities may be different layers or sublayers of the protocol stack. The Tx entity may be the physical, medium access control (MAC), radio link control (RLC), packet data convergence protocol (PDCP), PDU session, or service data adaptation protocol (SDAP) sending a packet to a corresponding physical layer, MAC, RLC, PDCP, PDU session, or SDAP of the Rx entity. For example, in an UL transmission from the UE 104 to the App server 124, the transmission control protocol (TCP) Internet protocol (IP) layer of the UE 104 may send an UL packet to the App server 124 as part of the payload. The TCP/IP layer of the App server 124 may send a TCP Ack message in the DL direction to the UE 104 upon successfully receiving the UL packet.

TCP/IP may use selective Ack or Sack. The receiving TCP sends back SACK packets to the sender, informing the sender of the data that has been received. The sender can then retransmit only the missing data segments. The TCP/IP may also enable timestamp options in which the receiver may measure packets' round-trip-time (RTT). The RTT may help the TCP/IP to set and adjust its retransmission timer.

In some instances, the transmitted packet may have a sequence number (SN). The SN may help to keep track of how much data has been transferred and received. The Ack associated with a received packet may include or be associated with the SN of the corresponding received packet. TCP/IP may work as a cumulative Ack scheme where the Ack may indicate the reception of all bytes in packets with sequence numbers smaller than the sequence number indicated by the Ack message. The cumulative Ack may be used with Sack and combined with the timestamps.

TCP applications typically use PDCP or RLC acknowledgment (AM) mode. The RLC AM mode protocol is designed to successfully transfer every upper layer service data unit (SDU) to the receiver by coordinated feedback from the receiver RLC. As a result, in RLC AM, the UE may be configured to transmit every TCP ACK.

High throughput applications may generate high rates of TCP Acks. For example, enhanced mobile broadband (eMBB) applications may require high throughput and, thus, may generate a relatively large number of TCP ACKs. For instance, TCP ACKs generated in response to a 20 gigabit per second (Gbps) eMBB stream may utilize up to 100 megabits per second (Mbps) of bandwidth. When RLC AM is utilized, each TCP ACK may be encapsulated into various 3GPP headers (e.g., SDAP, PDCP, RLC, MAC, etc.) and transmitted over the air. If TCP ACKs are lost and/or there is a channel error, the 3GPP lower layers may ensure that the TCP ACKs are retransmitted, and even more bandwidth may be consumed. The cumulative Acks carry redundant information, and not every TCP Ack needs to be transferred successfully for the TCP protocol to function. Therefore, processing ACKs on this scale may place a strain on power and/or processing resources. Accordingly, utilizing RLC AM for transferring TCP ACKs may have a negative impact on over-the-air resources, UE processing resources or network processing resources.

Cumulative packet processing is not limited to ACK or TCP traffic. Other applications such as, but not limited to, trivial file transfer protocol (TFTP) over user datagram protocol (UDP), quick UDP Internet connection (QUIC) for cumulative Ack frames, stream control transmission protocol (SCTP), IP security (IPSec), open shortest path first (OSPF), or other artificial intelligence (AI) algorithms, may generate cumulative packets.

In some legacy implementations, first-in-first-out (FIFO) queues are used to buffer data. In a FIFO buffer, the data that first entered in the buffer may be served first and before data that arrives later. However, a last-in-first-out (LIFO) queue may be more suitable to buffer and serve cumulative packets. In the LIFO queue, the last packet added to the queue is processed or served before packets that entered the queue earlier. In the case of cumulative packets, the later (in time) packets may include the information of the earlier packets. Therefore, as disclosed in some embodiment, the protocol may operate in cumulative mode (CM). When operating in CM mode, it may be sufficient to process and transmit the latest packet and discard or remove the earlier packets.

Operating in CM mode may require evaluating user plane traffic information on TCP/IP level, e.g., TCP Ack within an application layer traffic flow. However, the BS 108 may not have a full IP stack. Therefore, the UE 104 may filter and reduce the cumulative Acks sent in the UL and generated in response to the DL data traffic, but the BS 108 may not filter and reduce the TCP Ack in the DL generated in response to UL data traffic.

In some embodiments, the UPF 112 or the UE 104 may implement appropriate packet filters. The CM may operate on a per-packet or per-flow basis. For example, a packet detection rule (PDR) or a QoS rule may be used to map TCP Acks to a QoS flow. A dedicated QoS flow for the TCP Ack may enable the BS 108 to operate in CM, transmit only a few, e.g., the most recent or relevant TCP Ack packets, and discard the rest.

In one instance, the packets benefiting from cumulative processing, which may referred to as cumulative packets, e.g., TCP Ack, may originate within the same QoS flow, IP flow, or SDF. Identifying the traffic or packet types within a SDF or IP flow may be needed to separate the cumulative packets and apply a different packet ordering or treatment to those packets. For example, the legacy IP packet filters do not support identifying some types of packets, e.g., TCP Acks or QUIC acknowledgment frames.

In some embodiments, the packet filter set is extended. The packet filter set may be used in a QoS rule or a PDR to identify one or more packet flows. The packet filter set may be based on a policy charging and control (PCC) rule of 3GPP technical specifications (TSs).

In legacy systems, enciphering may be done in PDCP before RLC processing. Therefore, the removal of a packet, e.g., a packet considered superfluous due to cumulative ACK processing, in RLC may be considered a waste of processing resources and battery power. One reason to get rid of superfluous TCP Acks may be the processing overhead for ciphering, which typically is larger for smaller packets such as Ack packets. It may be more beneficial to flush the superfluous packets before enciphering.

In addition, removing packets from the queue may introduce an SN gap. When the removal happens after the SN assignment, RLC state variables need to be updated. Updating the RLC state variables may be computationally intensive. Furthermore, SN gaps in PDCP may cause a reordering delay at the PDCP receiver when the reordering timer is configured. The 3GPP specification does not allow an SN gap in RLC. Moreover, the removal of obsolete packets in RLC may occur after PDUs are submitted to lower layers. For example, the PDU may be part of a time-critical operation in RLC or MAC, e.g., the obsolete packets may be included in the logical channel prioritization (LCP) process. In the examples above, discarding packets may be complicated and computationally intensive. Therefore, it may be more energy efficient to send those PDUs.

In some embodiments, removing the superfluous packets may happen before those packets are admitted to the layer 2 (L2) queue, or a discard timer may be configured to flush the queue.

The use of LIFO instead of a FIFO queue may cause inconsistencies in queue operation, e.g., delay and latency of serving packets. Therefore, a LIFO queue may cause an unintended or non-deterministic drop or delay to packets pushed further down in the queue. The unintended delay or drop may not be a problem when the queue contains only cumulative packets, and the packets deep in the queue would be flushed. However, the queue is desired to contain multiple types of control and data packets.

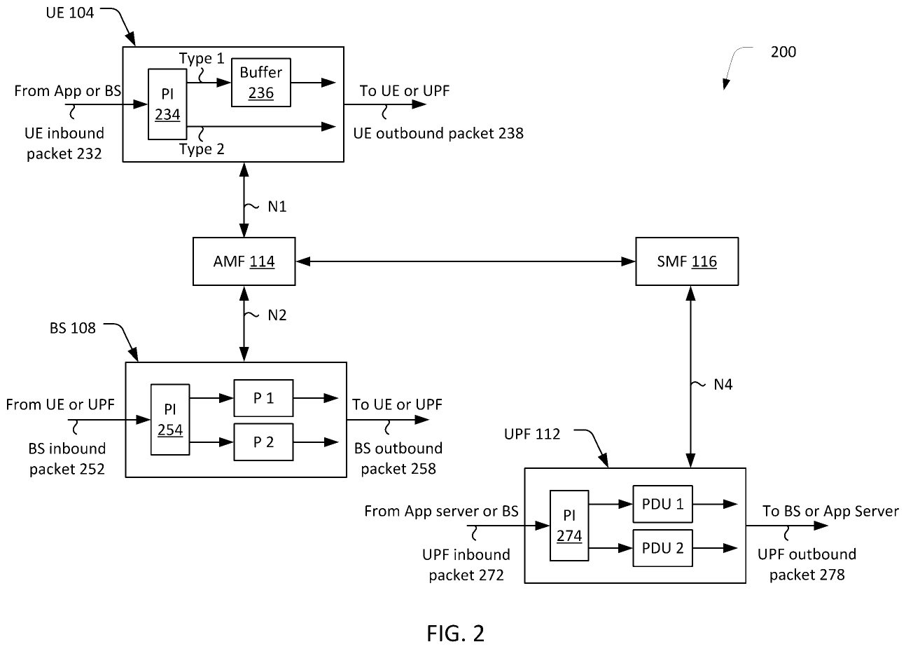

FIG. 2 illustrates a network environment 200 in accordance with some embodiments. Network environment 200 is an example of a CM using filters on a per-packet basis to identify and treat cumulative packets. Per packet, operation within a QoS flow may need a packet filter, e.g., TCP control flags, in a PDR at the UPF 112.

In one embodiment, the UE 104 may receive a UPF inbound packet 232. The packet inspection (PI) 234 inspects that packet. The PI 234 may identify whether the packet 232 contains redundant information, e.g., whether the packet is a cumulative packet. The UE 104 may separate the cumulative packets, e.g., Type 1, from the normal traffic, e.g., Type 2. The UE 104 may then use a CM processing, e.g., a LIFO processing, to queue the cumulative packets in buffer 236, send the latest or most recent cumulative packet, and discard the superfluous packets, e.g., by flushing the queue. The remaining packets are served and forwarded in the UE outbound packet 238.

The UE inbound packet 232 may be an UL packet received from the application. The UE outbound packet 238 may be an UL packet sent to the BS 108.

In one embodiment, the UE 104 may add a marking to the cumulative packets, e.g., Type 1, before forwarding it. For example, the UE 104 may add a marking on SDAP, PDCP, RLC, or MAC headers in UL transmission. The BS 108 may use the marking added to the packet to filter the cumulative packets.

In another embodiment, the UE 104 may use an associated or dedicated PDU set importance or priority to identify the cumulative packets. The BS 108 may use the marking to prioritize, discard, or not discard the marked packets.

In one embodiment, the UE implementation may identify cumulative packets intended for a DRB or RLC entity.

In one embodiment, the UPF 112 may receive a UPF inbound packet 272, which is inspected by PI 274. The PI 274 may identify whether the packet 272 contains redundant information, e.g., whether the packet is a cumulative packet. The UPF 112 may separate the cumulative packets, e.g., PDU 1, from the normal traffic, e.g., PDU 2. The UPF 112 may then use a CM processing, e.g., a LIFO processing, to queue the cumulative packets, send the latest or most recent cumulative packet, and discard the superfluous packets, e.g., by flushing the queue. The remaining packets are served and forwarded in UPF outbound packet 278.

The UPF inbound packet 272 may be an UL packet received from the BS 108 or a DL packet received from the DN or App server. The UPF outbound packet 278 may be an UL packet sent to the App server or a DL packet forwarded to the BS 108.

In one embodiment, the UPF 112 may add a marking to the cumulative packets, e.g., PDU 1, before forwarding it. For example, in DL transmission, the UPF 112 may add a marking on N3 in the general packet radio services (GPRS) tunneling protocol (GTP) user plane (GTP-U) or next-generation use plane (NG-U) interface. The BS 108 may use the marking added to the packet to filter the cumulative packets. For example, the UPF 112 may add information in a packet header, e.g., GTP-U header, or in PDU or multicast broadcast session (MBS) session user plane PDUs of the PDU session user plane protocol, e.g., based on the 3GPP TSs.

In one embodiment, the extra packet header may carry a marking that is used to indicate whether or not a packet benefits from cumulative processing or LIFO processing, e.g., indicating whether a packet is a cumulative packet. For example, the indication may be a one-bit indication where the value 1 may indicate that the packet is a cumulative packet, and a value of 0 may indicate that the packet is not a cumulative packet. Multiple bits may be used to carry additional information. For example, the marking may indicate a preference for LIFO operation along with CM. For example, the UL PDU SESSION INFORMATION message allows the UPF 112 to receive some control information elements associated with a packet transfer over the N3 interface. One or multiple of the spare bits of UL PDU SESSION INFORMATION (PDU Type 1) Format, in accordance with 3GPP TS 38.415 v.17.0.0 2022-04-06, may be used to indicate CM or LIFO over N3 on a per-packet basis. In another example, the DL PDU SESSION INFORMATION message allows the UPF 112 to receive some control information elements associated with a packet transfer over the N3 interface. One or multiple of the spare bits of DL PDU SESSION INFORMATION (PDU Type 0) Format, in accordance with 3GPP TS 38.415, may be used to indicate CM or LIFO over N3 on a per-packet basis.

In another embodiment, the UPF 112 may use an associated or dedicated PDU set importance or priority to identify cumulative packets. The BS 108 may use the marking to prioritize, discard, or not discard the marked packets. For example, the PDU set importance information may include multiple bits where one bit may indicate importance level, e.g., important and non-important, and other bits or importance levels may indicate whether the packet is a cumulative packet or LIFO or CM preferences.

In one embodiment, the BS 108 receives a BS inbound packet 252, which is inspected by PI 254. The PI 254 may identify whether the packet 252 contains redundant information, e.g., whether the packet is a cumulative packet. The BS 108 may separate the cumulative packets, e.g., P 1, from the normal traffic, e.g., P 2. The BS 108 may then use a CM processing, e.g., a LIFO processing, to queue the cumulative packets, send the latest or most recent cumulative packet, and discard the superfluous packets, e.g., by flushing the queue. The remaining packets are served and forwarded in BS outbound packet 258.

The BS inbound packet 252 may be an UL packet from the UE 104 or a DL packet from the UPF 112. The BS outbound packet 258 may be an UL packet sent to the UPF 112 or a DL packet forwarded to the UE 104.

In one embodiment, the BS 108 may receive a packet containing additional information in the packet header indicating whether the packet is a cumulative packet. The BS 108 may use this information to map the packet to an appropriate DRB in the DL.

In one embodiment, radio resource control (RRC) may configure a DRB for operation with per-flow cumulative mode or per-packet cumulative mode. Per-packet CM may be applicable to selected packets only. For example, packets that are identified based on new header fields, e.g., in GTP-U or NG-U, over user plane protocols, or based on meta information provided by the implementation. Alternatively, CM may be defined as a combined mode applicable to both per-packet or per-flow traffic, controlled by a single parameter. PDCP implementation may identify QoS flows based on upper layer configuration or based on DRB or RLC entity mapping, which in turn is controlled by the core network and the radio access network, e.g., over GTP-U and N2 or N3 configuration.

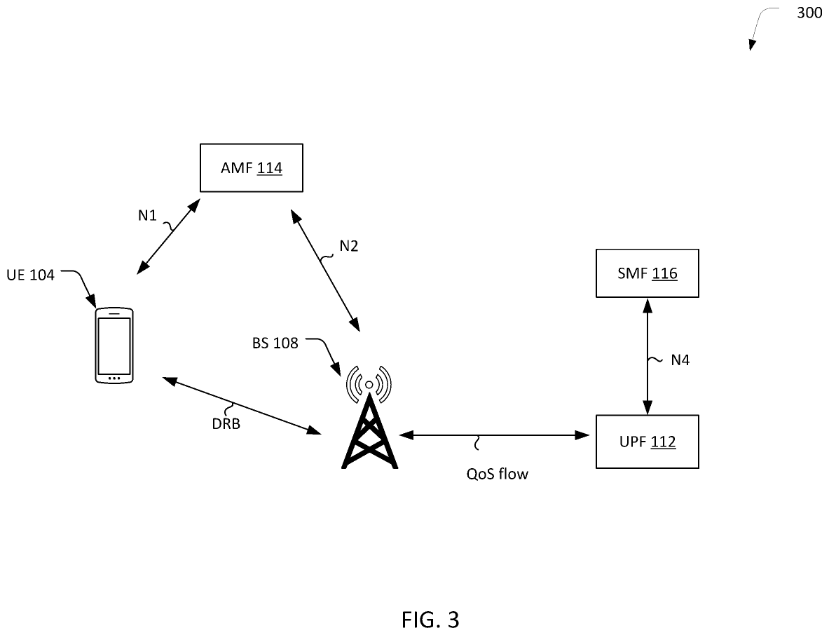

FIG. 3 illustrates a network environment 300 in accordance with some embodiments. Network environment 300 is an example of a CM using filters on a per-flow basis to identify and treat cumulative packets. Per-flow operation within a QoS flow may need a packet filter.

In one embodiment, the network may allocate a 5G QoS identifier (5QI) for the transport of cumulative packets. In another embodiment, the QoS flow may be marked as CM capable.

In one embodiment, the UE 104 may receive configuration by the AMF 114 over N1 or radio resource control (RRC) signaling to allocate a QoS flow or a DRB to cumulative packets. For example, the AMF 114 or RRC signaling may configure the UE to filter cumulative packets. The UE 104 may send or receive cumulative packets on the configured QoS flow or DRB. The UE 104 may implement CM processing or LIFO processing on the QoS flow or DRB associated with the cumulative packets. For example, the UE 104 may buffer the cumulative packets associated with the configured QoS flow or DRB, transmit the most recent packet in the buffer, and discard or process the remaining packets in the queue.

In one embodiment, the UPF 112 may receive configuration by the SMF 116 over N4 to identify cumulative packets and associate them with a QoS flow. For example, the UPF 112 may be configured with packet filters associated with a QoS flow to filter cumulative packets. The UPF 112 may send or receive cumulative packets on the configured QoS flow. The UPF 112 may implement CM processing or LIFO processing on the QoS flow associated with the cumulative packets. For example, the UPF 112 may buffer the cumulative packets associated with the configured QoS flow, transmit the most recent packet in the buffer, and discard or process the remaining packets in the queue.

In one embodiment, the BS 108 may be configured, e.g., by the AMF 114, over N2. The configuration may be per QoS flow. The BS 108 may be configured over N2 with LIFO operation or a discard timer. The configuration may indicate a QoS flow as CM capable. The BS 108 may receive packets associated with the CM-capable QoS flow. The BS 108 may perform CM processing or LIFO processing on the packets associated with the CM-capable QoS flow.

For example, the BS 108 may buffer the packets associated with the CM-capable QoS, forward the most recent packet, and discard the remaining superfluous packets.

In one embodiment, the RRC may configure a DRB for operation with per-flow CM as a new PDCP or RLC layer function. Per-flow CM may apply to traffic in a DRB, logical channel (LCH), RLC entity, QoS flow, PDU set importance value, PDU session, real-time transport protocol (RTP) session, traffic flow, or SDF. The RRC may configure PDCP or RLC with a sequence ordering property. For example, a new RRC parameter may be defined in the pdcp-config information element (IE) or rlc-config IE to identify the sequence ordering property. A UE capability may be defined to enable these modes.

In one embodiment, a new DRB mode may be allocated to distinguish between CM or LIFO for any packets, or for selected packets, or CM or LIFO for selected flows only.

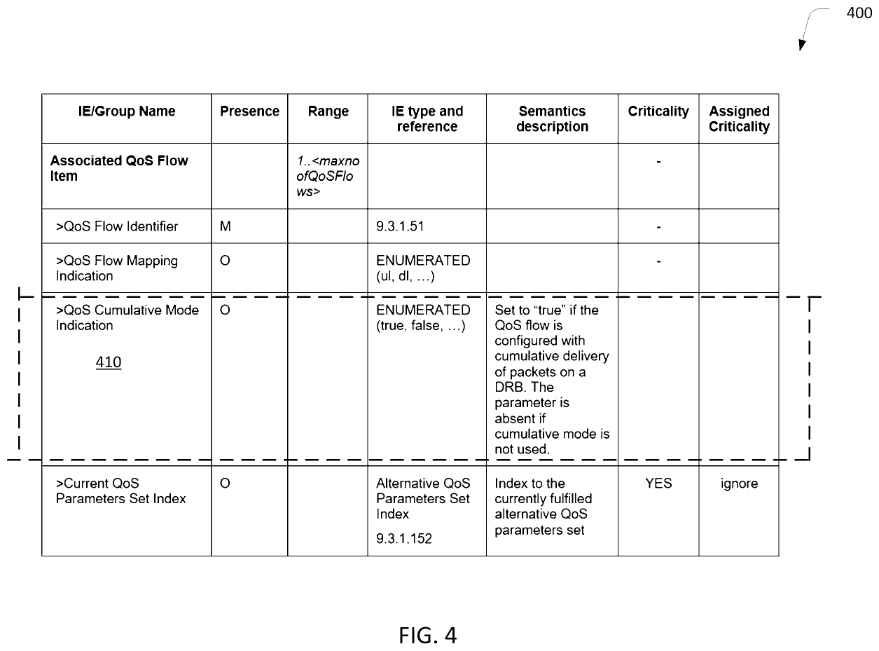

FIG. 4 illustrates an information element (IE) 400 in accordance with some embodiments. The IE 400 is an example of N2 parameters for configuring a BS with a CM-capable QoS flow in accordance with the 3GPP TS 38.413.

The IE parameter Qos Flow Identifier determines the QoS flow. The Qos Cumulative Mode Indication 410 indicates whether the identified QoS is configured to support CM processing. A “true” value indicates the QoS flow is configured with cumulative delivery of packets on a DRB on which the QoS flow is mapped. The parameter is absent when the cumulative mode is not used.

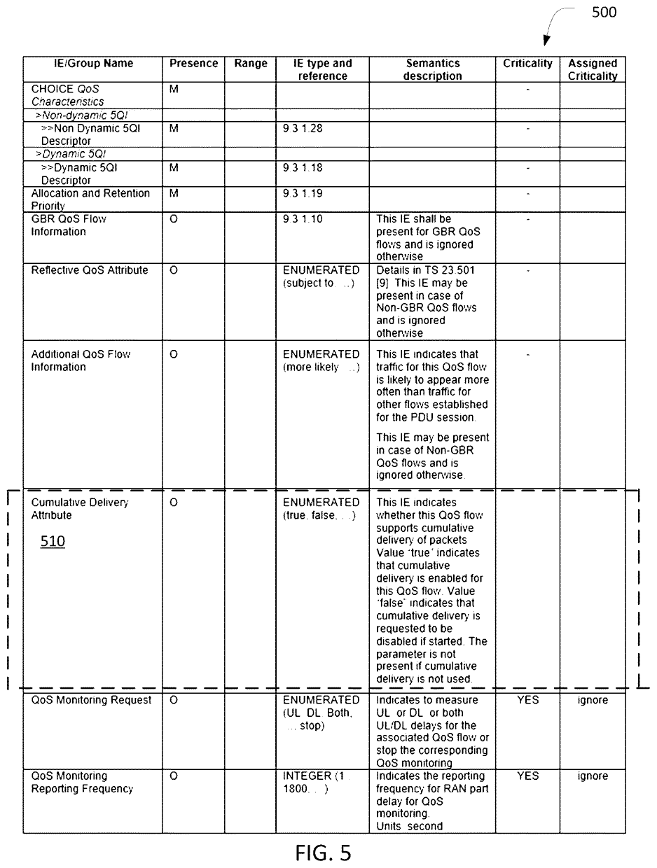

FIG. 5 illustrates an information element 500 in accordance with some embodiments. The IE 500 is an example of N2 parameters for configuring a BS with a CM-capable QoS flow in accordance with the 3GPP TS 38.413v17.4.0, 2023-04-03.

The Cumulative Delivery Attribute 510 indicates whether the identified QoS is configured. A “true” value indicates that cumulative delivery is enabled for this QoS flow. Value “false” may indicate that cumulative delivery is requested to be disabled if started. The parameter is not present if cumulative delivery is not used.

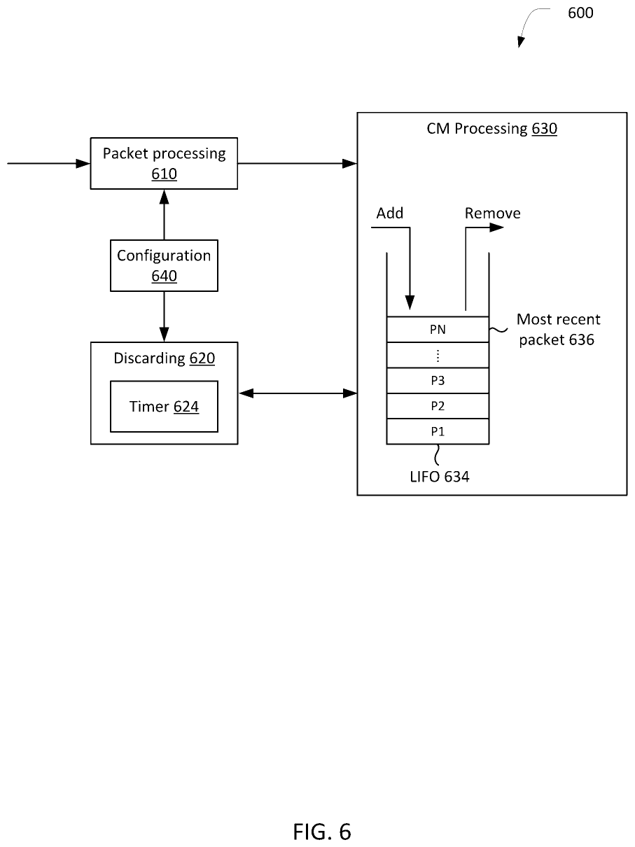

FIG. 6 illustrates a system block diagram 600 in accordance with some embodiments. The system block diagram 600 is an example of cumulative packet discarding.

The system block diagram 600 may be part of a network entity, e.g., a UE, BS, or a UPF.

Packet processing 610 may process the packets and identify cumulative packets. The packet processing 610 may send the packet to CM processing 630. The CM processing 630 may include a LIFO queue 634. The most recent packet 636 is added to the LIFO 634. The most recent packet 636 may be processed and served, e.g., forwarded. The CM processing 630 may discard the remaining packets in the LIFO 634, e.g., P1, . . . , PN-1. The network entity may receive a configuration 640 to configure the discarding 620. Discarding 620 may include a timer 624. Upon timer 624 expiry, the CM processing 630 may serve the most recent packet 636, if it is not served yet, and flushes the remaining superfluous packets.

In one embodiment, the PDCP cumulative mode with the least recently discarded or LIFO operation of the PDCP queue may be implemented by the UE.

In one embodiment, the remaining duplicated or superfluous packets may stay in the queue, and PDCP may use a dedicated PDCP discard timer. The timer is dedicated to a serving data unit (SDU). The time value or the maximum number of associated queue elements, e.g., SDUs or SDU segments, may be configurable.

When the discard timer expires for a PDCP SDU or the successful delivery of a PDCP SDU is confirmed by the PDCP status report, the transmitting PDCP entity may discard the PDCP SDU along with the corresponding PDCP data PDU. If the corresponding PDCP data PDU has already been submitted to lower layers, the discard is indicated to lower layers.

Discarding a PDCP SDU associated with a PDCP SN may cause an SN gap in the transmitted PDCP data PDUs, which may increase PDCP reordering delay in the receiving PDCP entity. The UE implementation may handle the SN gap after SDU discard.

When upper layers, e.g., PDCP, indicate the discarding of an RLC SDU, the transmitting side of an acknowledge mode (AM) RLC entity or the transmitting unacknowledge mode (UM) RLC entity may discard the indicated RLC SDU if neither the RLC SDU nor a segment thereof has been submitted to the lower layers. The transmitting side of an AM RLC entity may not introduce an RLC SN gap when discarding an RLC SDU.

In one embodiment, the RLC at both the transmitter and the receiver may have information related to the discarded RLC SDUs. RLC may use this information at the transmitter to avoid retransmission, at the receiver to move the reassembly window forward or stop reassembly of the current SDU, or at the receiver in RLC AM to send an RLC status report with an update on Ack/Nack status, e.g., indicating those discarded in-flight packets as Acked. A discard indication from the transmitter may trigger this.

The discarding entity may discard cumulative Ack packets using Ack suppression. The Ack packets may not be needed to be placed in the queue. The transmitter checks the packets based on header or metadata before moving them forward to, e.g., PDCP.

Ack suppression, known as TCP Ack filtering, prevents admitting Ack with lower-numbered Ack. The Ack timer removes older Acks from the buffer if they are admitted to the queue, but a more recent Ack arrives later, e.g., before those packets can get processed or transmitted.

In one embodiment, the network entity may be configured with CM in the service data adaptation protocol (SDAP) sublayer. The SDAP does not have its own sequence numbering, which reduces the complexities associated with packet removal described above.

In one embodiment, the UE may indicate CM or LIFO support for a particular layer or specific DRBs, QoS flows, IP flows, SDF, or PDU set. It may be sufficient if one protocol layer, e.g., the highest layer, supports CM. Lower layers may follow the packet order provided by the higher layers. Packet discarding may also be done as a bearer configuration.

Operating a transmitter in CM implies that most recently received packets may be transmitted first, e.g., using a LIFO queue or a stack. As a result, some of the earlier packets may become obsolete, e.g., cumulative Acks. A timer 624 may be used to remove those packets from a buffer or a queue. The timer 624 may run in an operating system (OS) task context o the application processor or on the modem itself. The timer 624 may be designed such that obsolete packets, e.g., older TCP Acks, are flushed away while the timer is running, and packets are submitted to the RLC CM bearer for processing when the timer expires. In one example, the UE queue is flushed on the expiration event.

In one embodiment, the discarding process may not use a timer. The CM processing 630 may check upon queue entry to determine whether the packet needs to be discarded. In another implementation, the entity, e.g., UE, BS, or UPF, implementation may handle the timer details, e.g., value, and operation, e.g., discarding and processing the queue based on the timer 624.

In one embodiment, an intermediate buffer may be used, and multiple SDUs may be associated with one timer 624. The network entity may do nothing while the timer is running. Upon timer expiry, obsolete or duplicated packets are flushed away, and valid packets are submitted to the bearer, e.g., PDCP, RLC, or whatever layer is configured for CM.

In some embodiments, the intermediate buffer may not be used. In a first option, the upper layers may submit packets into the transmission queue, e.g., continuously, whenever they arrive. Before admission to the queue, packets are checked for their eligibility to be flushed away. The timer 624, e.g., one timer instance per SDU or for a group of packets, may be started once a packet is admitted. If the packet is still in the queue when the timer 624 expires, it can be flushed away. In a second option, upper layers may submit packets into the transmission queue, e.g., continuously whenever they arrive. Before admission to the queue, packets are checked for their eligibility to be flushed away. The timer 624, e.g., one timer instance per SDU or for a group of packets, may be started once a packet is admitted. If the packet is still in the queue when the timer expires, the protocol entity checks if a later packet has meanwhile arrived in the queue, and if so, the packet is discarded. If not, the timer could be restarted if desired. The timer 624 may be thought of as a discard timer.

In one embodiment, the timer 624 may be configured such that cumulative Acks can have a different timer value than other control packets on the same DRB. The timer value may be implementation specific, configured by the BS over Uu to the UE, proposed by the UE in UE assistance information (UAI), specific to a QoS flow, DRB, logical channel (LCH), IP traffic flow, SDF, or configured by the AMF or SMF over N2.

In one embodiment, CM or LIFO processing, irrespective of the timer 624, may be configured by the network for a DRB, QoS flow, traffic flow, or LCH. If configured per DRB, the config may optionally include a configuration per RLC entity, where multiple RLC entities associated with a DRB may use different RLC modes.

In one embodiment, the UE, via UAI, may request or propose using CM or LIFO. CM or LIFO may be configured by the network for a DRB, QoS flow, traffic flow, or LCH. If configured per DRB, the config may include a configuration per RLC entity, where multiple RLC entities associated with a dRB may use different RLC modes. The UE may propose using CM or LIFO via UAI.

In one embodiment, CM configuration may disable, e.g., as a default option, PDCP, or SDAP concatenation when CM or LIFO is enabled on a DRB. SDU concatenation may imply additional delay due to the concatenation of several SDUs. Plus, it does not allow for the finer granularity to process packets earlier than others.

In one embodiment, the BS or the UPF may remove the superfluous packets. The flushing may be performed before the allocation of a sequence number and an early stage of PDR processing before the packets are admitted to a QoS flow. The end user may have to provide consent as the flushing may involve the network taking away the user's packets in an IP flow, SDF, QoS flow, or LCH. In addition, charging aspects need to be considered as well because the network should not charge for the discarded packets.

When uplink data compression (UDC) or robust header compression (RoHC) may depend on in-order processing, RRC may not configure CM or LIFO together with UDC or ROHC.

The network may be able to enable or disable cumulative mode for a protocol layer. The network can separately configure the CM or LIFO. Network configuration may be based on the UE capability and UE preference indication. In the first option, L2 layers can be configured via RRC with the following alternatives: 1) PDCP only, 2) RLC only, 3) both RLC and PDCP, either through separate RRC parameters or a combined RRC config, 4) RLC, PDCP, and SDAP, either as separate RRC parameters for each layer or a combined RRC config, 5) all L2 layers operate as CM or LIFO, or 6) implementation or layers above SDAP.

In a second option, at least one upper layer, e.g., above SDAP, may be configured to operate in CM or LIFO mode. The upper layer may be configured via nonaccess stratum (NAS) or higher layers, e.g., SDP, for a QoS flow, IP flow (SDF), or on a per-packet basis.

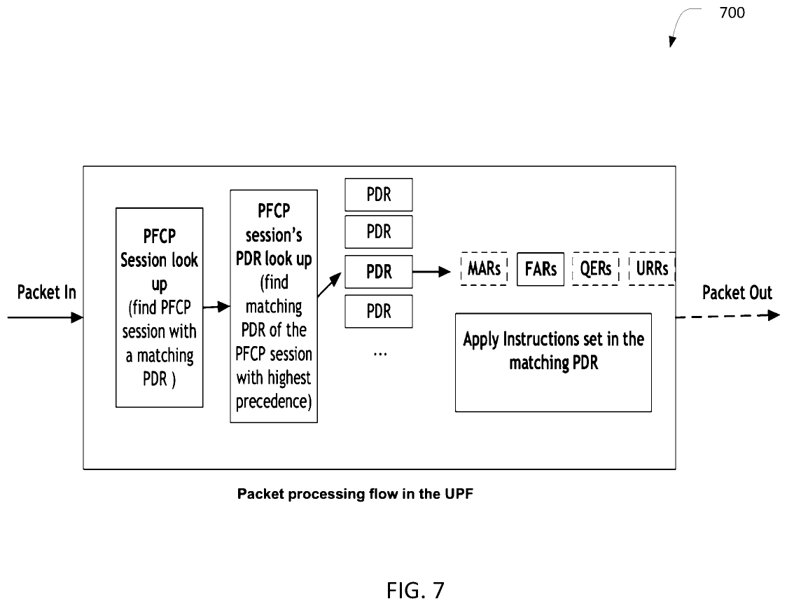

FIG. 7 illustrates a system block diagram 700 in accordance with some embodiments. Block diagram 700 is an example of packet processing flow in the UPF. The packet forwarding control protocol (PFCP) finds the PFCP session and sets up the PDR handling, e.g., PDF processing. One PDR may be associated with the CM processing or detection of cumulative packets. Once the PDR identifies the cumulative packets, they may be marked, removed, or processed by the CM or LIFO processing. In addition to PDR, the parameters over N4 provided from SMR to UPF may include forwarding action rules (FAR), multi-access rules (MAR), usage reporting rules (URR), QoS enforcement rules (QER), or session reporting rules (SRR).

Packet detection may be performed by packet filtering. A packet filter set is used in a QoS rule and a PDR to identify one or more packet flows. Further, the packet filter set is based on a PCC rule. A packet filter set may consist of, e.g., a 5-tuple or 2-tuple.

It is possible to extend the packet filter set by an additional set of packet filters. The packet filter set may support packet filters based on at least any combination of 1) source or destination IP address of Ipv6 prefix, 2) source or destination port number, 3) protocol ID of the protocol above IP or next header type, 4) type of service (TOS) (Ipvvr) or traffic class (Ipv6) and mask, 5) flow label (Ipv6); 6)security parameter index, 7) packet filter direction, 8) TCP control flags, 9) cumulative mode based condition, and 10) payload based condition.

In one embodiment, packet filters may be used on both UPF and UE sides. The TCP control flags may be used to identify TCP Acks. The CM-based condition may be any of the upcoming cumulative Acks methods like QUIC acknowledgment, stream control transmission protocol (SCTP) Ack, etc. The CM-based condition may be another protocol used in a specific context. Further, the payload-based condition may be a specific header field in IP payload that may allow for deep packet investigation (DPI). A protocol description may be defined based on input from an application function (AF) or access stratum (AS), e.g., to build PDRs in the UPF. For example, it may be achieved by an extension to N4 interface.

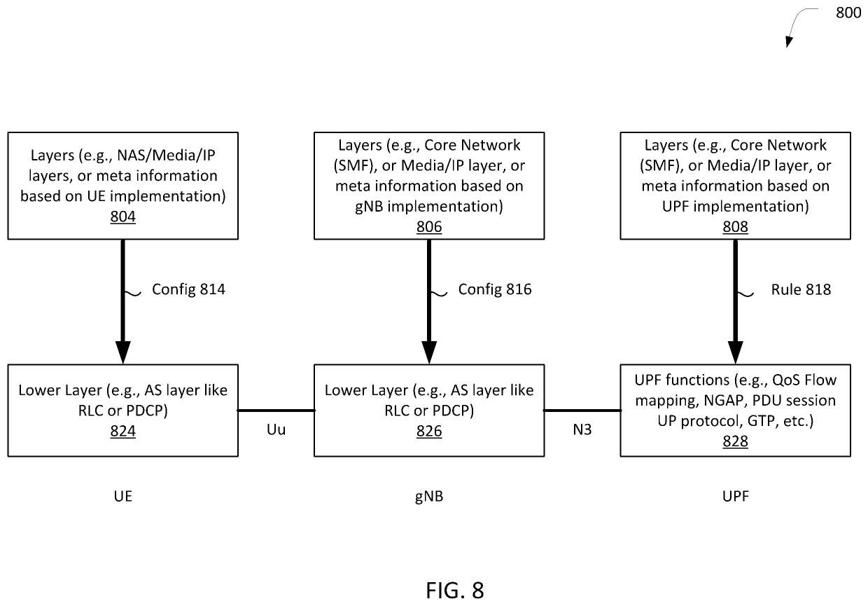

FIG. 8 illustrates a block diagram 800 of layer operations in various network entities in accordance with some embodiments. Block diagram 800 is an example of network layers indicating whether a flow or a packet is capable of CM or LIFO.

In one embodiment, the upper layers of the IP stack may provide an indication to lower layers where upper media or IP layers inform lower layers of the CM or LIFO configuration and lower layers, e.g., PDCP or RLC) apply the respective configuration for the traffic flow, RTP session or stream, PDU session, QoS flow, PDU Set, PDU Set type, DRB, or logical channel. In another embodiment, the indication may be provided by non-access stratum (NAS).

In one instance, the UE's layers 804, e.g., NAS, media, IP layers, or meta information based on UE implementation, sends the configuration 814 to configure lower layers, e.g., access stratum layers like RLC or PDCP.

In one instance, the BS's layers 806, e.g., the core network (SMF) or Media, IP layers, or meta information based on BS implementation, sends the configuration 816 to configure lower layers, e.g., access stratum layers like RLC or PDCP.

In one instance, the UPF's layers 808, e.g., the core network (SMF) or Media, IP layers, or meta information based on UPF implementation, sends the configuration 814 to configure UPF functions, e.g., QoS flow mapping, NGAP PDU session UP protocol.

In one embodiment, the network may configure the UE behavior of CM or LIFO to upper layers with a configuration per radio bearer, per QoS flow, per PDU session, per RTP session, per extended radio (XR) traffic flow, per PDU set type, per SDF, or per-packet. There are several options for end-to-end configuration of the CM or LIFO operations.

In a first configuration option, the CM or LIFO may be indicated as a property of a QoS flow. In one instance, the core network may configure the radio access network, e.g., the BS or the UE, in the DL direction. The network may configure the UE via NAS, e.g., as part of the QoS rule used to map a traffic flow to a QoS flow identifier (QFI). Once configured, the NAS layer may inform the access stratum of the CM or LIFO property associated with the QFI. In another instance, a CM or LIFO indication may be present in all packets of a QoS flow, e.g., using user plane packet headers associated with the traffic between the UE and the UPF.

In one embodiment, the network may configure the endpoints, e.g., the UE, BS, or UPF, separately via the control plane. The network may configure the UE in QoS rules or NAS signaling. The network may configure the BS via N2 and the UPF in PDRs via N4. In one instance, the SMF based on input and configurations from PCF or application function (AF) may configure the endpoints. The SMF may configure the endpoints by sending a CM list containing 5Qis or QFIs that support CM or LIFO. The SMF may configure the endpoints by a CM flag in the characteristics of the QoS flow configuration to indicate that the QoS flow supports CM or LIFO. For example, the CM flag may be a field in the QoS flow description or QoS rule.

The 3GPP specification may define a list of standardized 5Qis which support CM or LIFO. This may include the definition of new 5QIs. For example, a group of services, e.g., internet or video services, may be accompanied by a new 5QI that specifically supports CM or LIFO. A CM or Lifo configuration could be defined in the QoS characteristics as a QoS parameter associated with the 5QI.

In a second option, the network may indicate CM or LIFO as a property of a traffic flow or SDF. The property may be a characteristic in an SDF template, e.g., a special packet filter in an IP 5-tuple filter or the presence of a header or a payload-based condition. The property may be used to map the SDF to one or more QoS flows.

In a third option, the network may indicate CM or LIFO in a PDU header field that can be signaled over the user plane on a per-packet basis. For example, a new header, e.g., a 1-bit field, may indicate CM or LIFO in Uu, F1 (point-to-point interface between endpoints), or N3 interfaces. The indication may be used or set for selected packets only.

In a fourth option, the network may define a set of criteria to describe how to detect CM or LIFO characteristics based on packet header fields in upper layer payload, e.g., using DPI. The criteria may be fixed, e.g., configured or specified, as an option that can be enabled for certain configured or specified protocols or left to the implementation.

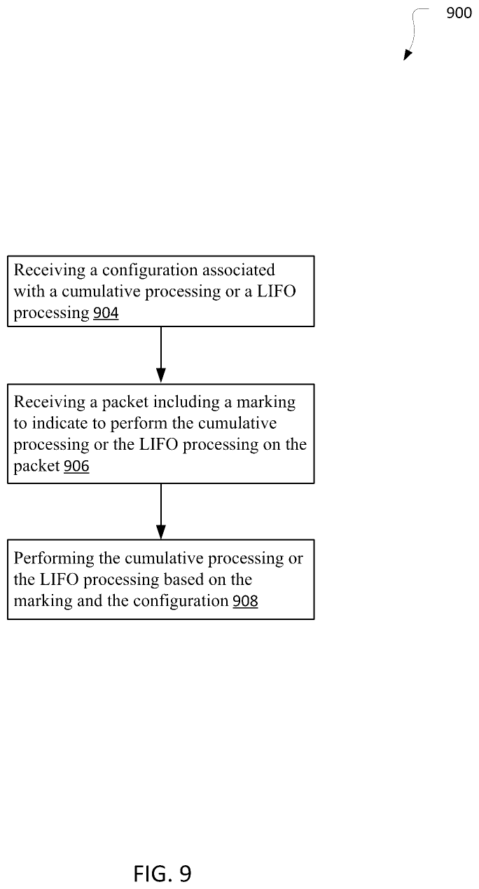

FIG. 9 illustrates an operational flow/algorithmic structure for per-packet CM or LIFO processing in accordance with some embodiments. The operation flow/algorithmic structure 900 may be implemented by a UE (for example, UE 104 or UE 1400) or components therein, for example, processing circuitry 1404, a BS (for example, BS 108 or BS 1500), or a UPF of a network entity (for example, NN 1500) or components therein, for example, processing circuitry 1504.

The operation flow/algorithmic structure 900 may include, at 904, receiving a configuration associated with cumulative processing or LIFO processing. The configuration may configure a network entity, e.g., a UE, a BS, or a UPF. The configuration may enable the network entity to perform CM or LIFO or to receive packets and flows associated with cumulative packets, flows, sessions, or bearers. The configuration may also add packet filters needed to inspect packets and identify the cumulative packets.

The operation flow/algorithmic structure 900 may include, at 906, receiving a packet, including a marking to indicate to perform the cumulative processing or the LIFO processing on the packet. The packet may include an indication in a header. The marking may indicate that the packet is a cumulative packet.

The indication may be based on PDU set importance or priority information. For example, the one or more bits of the packet's important information may be allocated indicate whether the packet is a cumulative packet.

The operation flow/algorithmic structure 900 may include, at 908, performing the cumulative or LIFO processing based on the marking and the configuration. The processing may include adding the cumulative packet to the buffer. The buffer may be implemented using LIFO or stack. The most recently arrived cumulative packet may be processed and forwarded toward the destination.

The network entity may implement a discarding mechanism to flush the buffer. For example, the network entity may include a discard timer that the buffer is flushed upon the expiry.

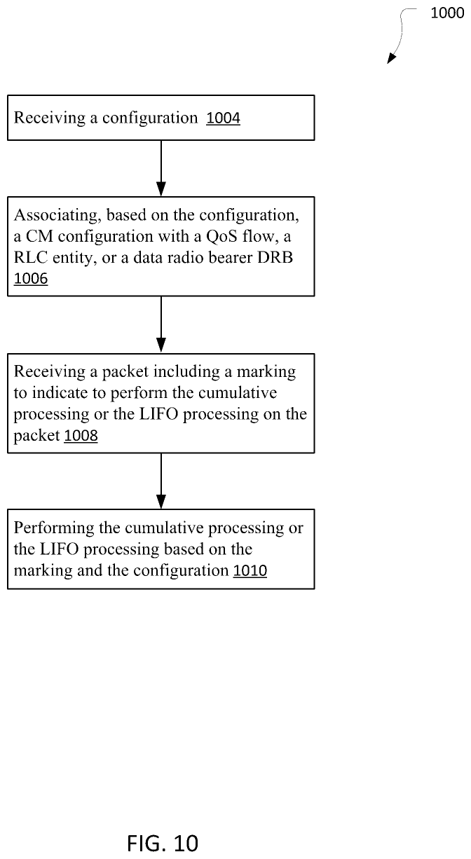

FIG. 10 illustrates an operational flow/algorithmic structure 1000 for per-flow CM or LIFO processing in accordance with some embodiments. The operation flow/algorithmic structure 1000 may be implemented by a UE (for example, UE 104 or UE 1400) or components therein, for example, processing circuitry 1404, a BS (for example, BS 108 or BS 1500), or a UPF of a network entity (for example, NN 1500) or components therein, for example, processing circuitry 1504.

The operation flow/algorithmic structure 1000 may include, at 1004, receiving a configuration associated with cumulative processing or a LIFO processing. The configuration may configure a network entity, e.g., aUE, a BS, or a UPF. The configuration may enable the network entity to perform CM or LIFO or to receive packets and flows associated with cumulative packets, flows, sessions, or bearers. The configuration may also add packet filters needed to inspect packets and identify the cumulative packets.

The operation flow/algorithmic structure 1000 may include, at 1006, associating, based on the configuration, a CM configuration with a QoS flow, an RLC entity, or a data radio bearer DRB. The AMF or SMF may configure the UE, BS, or UPF with the CM configuration associated with a QoS flow.

The operation flow/algorithmic structure 1000 may include, at 1008, receiving a packet, including a marking to indicate to perform the cumulative processing or the LIFO processing on the packet. The packet may include an indication in a header. The marking may indicate that the packet is associated with a cumulative flow or DRB.

The indication may be based on PDU set importance or priority information. For example, the size of the packet's important information may be extended and allocated one or more bits to indicate whether the packet is a cumulative packet.

The operation flow/algorithmic structure 1000 may include, at 1008, performing the cumulative or LIFO processing based on the marking and the configuration. The processing may include adding the cumulative packet to the buffer. The buffer may be implemented using LIFO or stack. The most recently arrived cumulative packet may be processed and forwarded toward the destination.

The network entity may implement a discarding mechanism to flush the buffer. For example, the network entity may include a discard timer that the buffer is flushed upon the expiry.

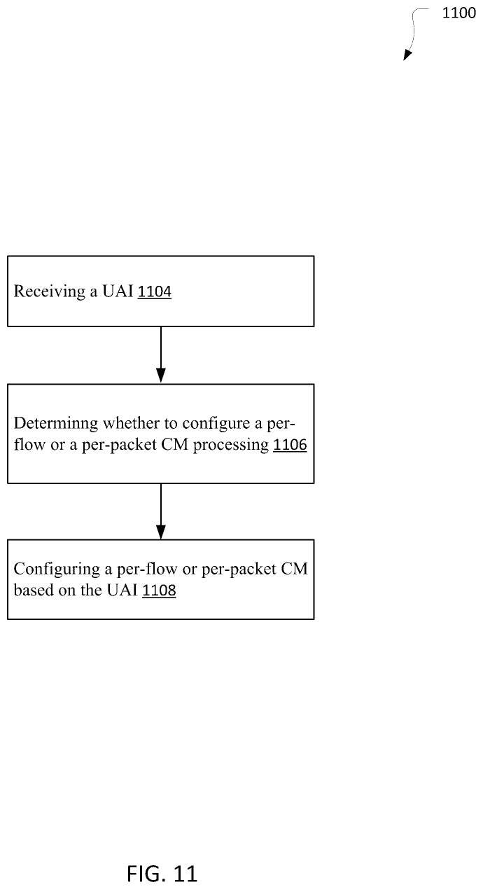

FIG. 11 illustrates an operational flow/algorithmic structure 1100 in accordance with some embodiments. The operation flow/algorithmic structure 1100 may be implemented by a BS (for example, BS 108 or BS 1300) or components therein, for example, processing circuitry 1304.

The operation flow/algorithmic structure 1100 may include, at 1104, receiving a UAI. In one embodiment, the UE may provide UE assistance information (UAI) or signaling to the BS to indicate its preference for per-flow or per-packet CM (or LIFO). For example, the UE may indicate whether it would prefer to activate or deactivate per-flow or per-packet CM or LIFO on one or more DRBs, RLC entities, QoS flows, or PDU set types. The UE may suggest an associated discard timer value. The UE may indicate which state of per-flow or per-packet CM behavior it would like to apply for one or more DRBs, RLC entities, QoS Flows, or PDU set types.

The operation flow/algorithmic structure 1100 may include, at 1106, determining whether to configure a per-flow or a per-packet CM processing. Upon reception of the UAI, the BS may evaluate whether per-flow or per-packet CM or LIFO behavior should or could be configured according to UE's preference.

The operation flow/algorithmic structure 1100 may include, at 1108, configuring a per-flow or per-packet CM based on the UAI. The BS may configure the per-flow or per-packet CM or LIFO according to UE's preference. The BS may send a response message to the UE indicating whether it would or would not configure the per-flow or per-packet CM, or LIFO per the UE's preference.

In one instance, the UE may indicate a preference for certain packet types or flows to apply CM over the NAS layer. The UE may use packet filter handling through NAS to apply CM to packets or flows over the NAS layer.

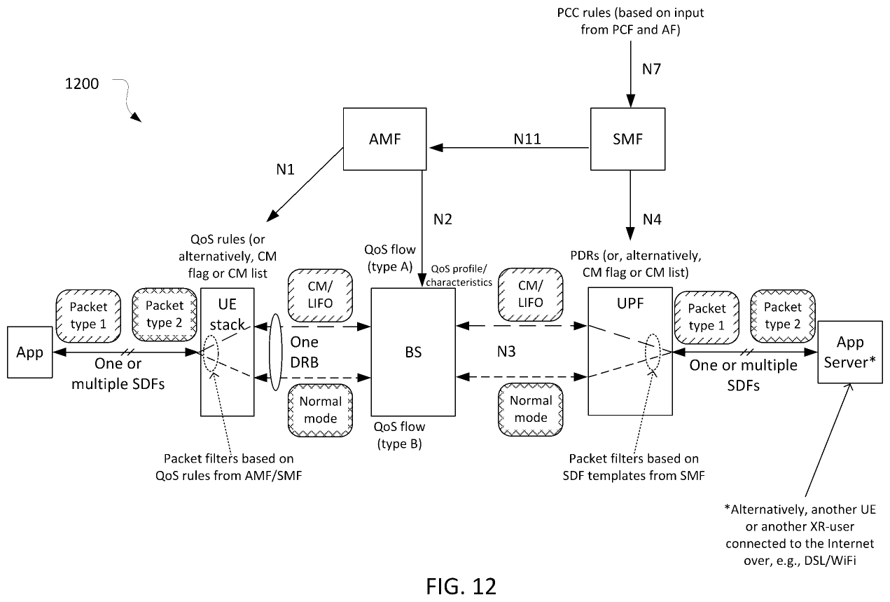

FIG. 12 illustrates an end-to-end block diagram 1200 implementing a per-flow CM or LIFO processing in accordance with some embodiments. PCC rules (based on input from PCF) may determine the network end-to-end policy for handling cumulative packets. SMF may receive PCC rules over an N7 interface. The SMF may provide the proper policies to the AMF over an N11 interface.

The end-to-end system 1200 may include an application that may generate traffic for uplink transmission destined for the app server. The application may be the destination of DL traffic. The UL traffic from the application or the DL traffic coming to the application may be organized in one or more SDFs. Each SDF may include one or more types of packets. For example, an SDF may include a cumulative packet, e.g., packet type 1, or non-cumulative packets, e.g., packet type 2.

The UE protocol stack may be configured with QoS rules or CM flag or CM list by the AMF or SMF through an N1 interface. The QoS rules may include packet filters. For example, one QoS flow, e.g., QoS flow type A, may be configured to handle cumulative packets, and another, e.g., QoS flow type B, for non-cumulative packets.

The BS, e.g., the gNB, may configure one or more DRBs. One DRB may be allocated to transport cumulative packets. In the DL transmission, the UE may be able to process the cumulative packets based on the QoS or DRB associated with the packet. Similarly, in the UL the gNB may be able to identify the cumulative packets mapped to a QoS flow or DRB that are configured to handle cumulative packets and apply CM processing to them. The gNB may receive one or more QoS profiles or characteristics configurations associated with the CM or LIFO processing from AMF over N2.

The N3 may provide an interface between gNB and UPF. A QoS flow may be allocated for handling the cumulative packets between gNB and UPF. The N3 may transport QoS flow assigned to cumulative packets, or QoS flows assigned to normal traffic, e.g., non-cumulative packets.

The UPF may be configured by SMF over N4 with PDRs, CM flags, or CM lists to perform CM or LIFO processing. The UPF may identify cumulative packet traffic based on the configured PDRs, CM flag, CM list, or packet filters based on SDF templates from SMF and apply CM or LIFO processing on the cumulative packets. The UPF my send or receive SDFs from an app server. Alternatively, another UE or another Xr-user connection to the internet may be connected to the UPF instead of the app server.

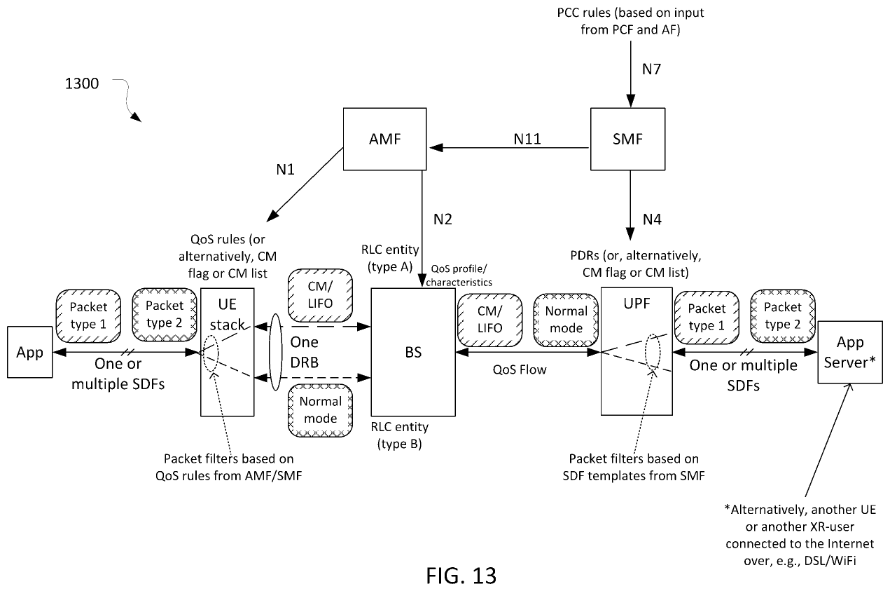

FIG. 13 illustrates an end-to-end block diagram 1300 implementing a per-packet CM or LIFO processing in accordance with some embodiments. PCC rules (based on input from PCF) may determine the network end-to-end policy for handling cumulative packets. SMF may receive PCC rules over an N7 interface. The SMF may provide the proper policies to the AMF over an N11 interface.

The end-to-end system 1300 may include an application that may generate traffic for uplink transmission destined for the app server. The application may be the destination of DL traffic. The UL traffic from the application or the DL traffic coming to the application may be organized in one or more SDFs. Each SDF may include one or more types of packets. For example, an SDF may include a cumulative packet, e.g., packet type 1, or non-cumulative packets, e.g., packet type 2.

The UE protocol stack may be configured with QoS rules or CM flag or CM list by the AMF or SMF through an N1 interface. The QoS rules may include packet filters. For example, one QoS flow, e.g., QoS flow type A, may be configured to handle cumulative packets, and another, e.g., QoS flow type B, for non-cumulative packets. The UE may add markings to the cumulative packets in the UL.

The BS, e.g., the gNB, may configure one DRB to carry cumulative and non-cumulative packets. The UE and the gNB may identify and separate cumulative packets based on a marking in the header of the packets. One or more headers in each packet may include an indication of whether the packet is a cumulative packet. The gNB may receive one or more RLC entities configuration, or QoS profiles or characteristics configurations associated with the CM or LIFO processing from AMF over N2. For example, one RLC, e.g., RLC entity type A, may be allocated to cumulative packet traffic, and another RLC entity, e.g., RLC entity type B, to non-cumulative packets.

The N3 may provide an interface between gNB and UPF. A QoS flow may be configured to carry both cumulative and non-cumulative packets. The UPF and gNB may identify cumulative packets from a marking in the header.

The UPF may be configured by SMF over N4 with PDRs, CM flags, or CM lists to perform CM or LIFO processing. The UPF may identify cumulative packet traffic based on the configured PDRs, CM flag, CM list, packet filters based on SDF templates from SMF, or the markings in the packet header and apply CM or LIFO processing on the cumulative packets. The UPF my send or receive SDFs from an app server. Alternatively, another UE or another Xr-user connection to the internet may be connected to the UPF instead of the app server.

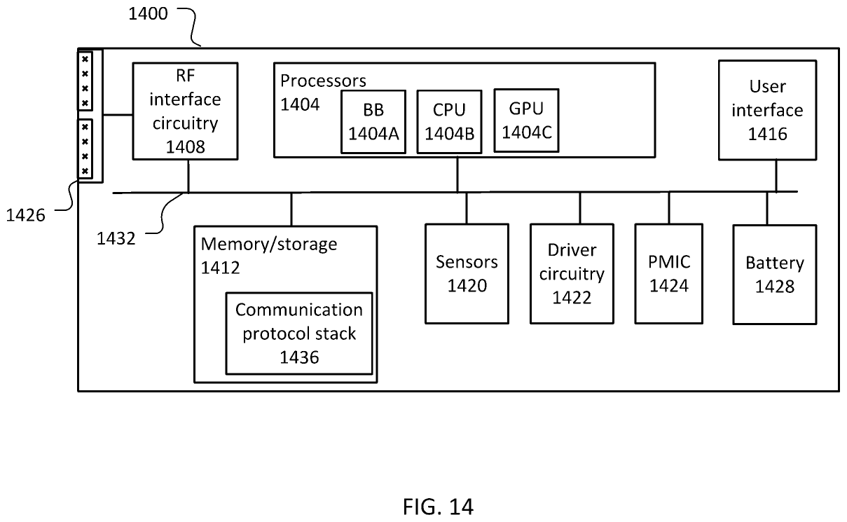

FIG. 14 illustrates a UE 1400 in accordance with some embodiments. The UE 1400 may be similar to and substantially interchangeable with UE 104 of FIG. 1.

The UE 1400 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangements of the components shown may occur in other implementations.

The components of the UE 1400 may be coupled with various other components over one or more interconnects 1432, which may represent any type of interface, input/output, bus (local, system, or expansion), transmission line, trace, or optical connection that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

The processors 1404 may perform operations associated with the CM processing or LIFO processing on a per-packet or per-flow basis consistent with embodiments described herein.

In some embodiments, the baseband processor circuitry 1404A may access a communication protocol stack 1436 in the memory/storage 1412 to communicate over a 3GPP-compatible network. In general, the baseband processor circuitry 1404A may access the communication protocol stack 1436 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 1412 may include one or more non-transitory, computer-readable media that includes instructions (for example, the communication protocol stack 1436) that may be executed by one or more of the processors 1404 to cause the UE 1400 to perform various operations described herein. The memory/storage 1412 includes any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processor 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, or phased array antennas. The antenna 1426 may have one or more panels designed for specific frequency bands, including bands in FR1 or FR2.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various I/O devices that may be present within or connected to the UE 1400. For example, the driver circuitry 1422 may include circuitry to facilitate the coupling of a universal integrated circuit card (UICC) or a universal subscriber identity module (USIM) to the UE 1400. For additional examples, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage the power provided to various components of the UE 1400. In particular, with respect to the processors 1404, the PMIC 1424 may control power-source selection, voltage scaling, battery charging, or DC-to-DC conversion.

In some embodiments, the PMIC 1424 may control or otherwise be part of various power-saving mechanisms of the UE 1400, including DRX, as discussed herein.

A battery 1428 may power the UE 1400, although in some examples, the UE 1400 may be mounted and deployed in a fixed location and may have a power supply coupled to an electrical grid. The battery 1428 may be a lithium-ion battery, a metal-air battery, such as a zinc-air battery, an aluminum-air battery, a lithium-air battery, and the like. In some implementations, such as in vehicle-based applications, the battery 1428 may be a typical lead-acid automotive battery.

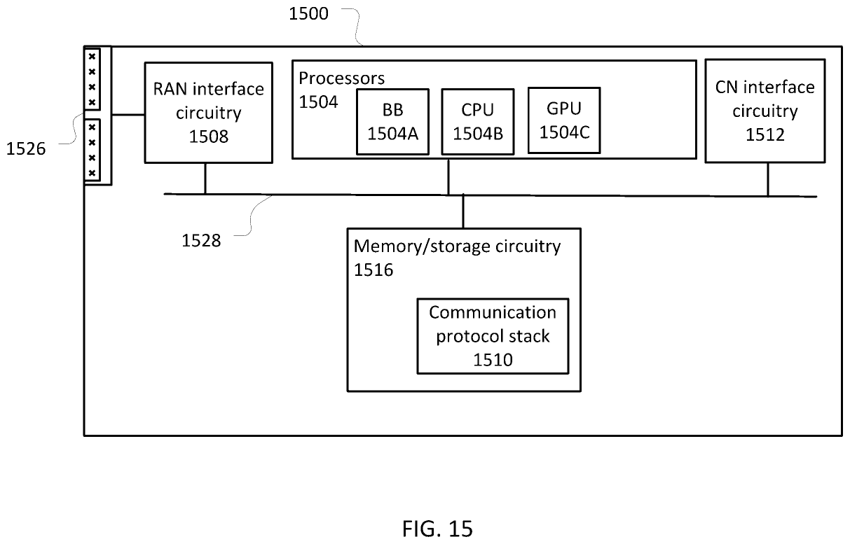

FIG. 15 illustrates a network node 1500 in accordance with some embodiments. The network node 1500 may be similar to and substantially interchangeable with base station 108, a device implementing one of the network hops, an integrated access and backhaul (IAB) node, a network-controlled repeater, or a server in a core network or external data network.

The network node 1500 may include processors 1504, RF interface circuitry 1508 (if implemented as an access node), the core node (CN) interface circuitry 1512, memory/storage circuitry 1516, and antenna structure 1526.

The components of the network node 1500 may be coupled with various other components over one or more interconnects 1528.

The processors 1504, RF interface circuitry 1508, memory/storage circuitry 1516 (including communication protocol stack 1510), antenna structure 1526, and interconnects 1528 may be similar to the like-named elements shown and described with respect to FIG. 14.

The processors 1504 may perform operations associated with the CM processing or LIFO processing on a per-packet or per-flow basis consistent with the embodiments described herein.

The CN interface circuitry 1512 may provide connectivity to a core network, for example, a 5th Generation Core network (5GC) using a 5GC-compatible network interface protocol such as carrier Ethernet protocols or some other suitable protocol. Network connectivity may be provided to/from the network node 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

In some embodiments, the network node 1500 may be coupled with transmit-receive points (TRPs) using the antenna structure 1526, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### Examples

In the following sections, further exemplary aspects are provided.

Example 1 includes a method of operating a network element (NE), the method including: receiving a configuration associated with a cumulative processing or a last-in-first-out (LIFO) processing; receiving a packet including a marking to indicate to perform the cumulative processing or the LIFO processing on the packet; and performing the cumulative processing or the LIFO processing based on the marking and the configuration.

Example 2 includes the method of example 1 or some other examples herein, wherein the NE is a base station (BS), a user plane function (UPF), or a user equipment (UE).

Example 3 includes the method of examples 1 or 2 or some other examples herein, wherein: the packet is a general packet radio service (GPRS) tunneling protocol user plane (GTP-U) packet, a next-generation (NG) user-plane interface (NG-U) packet, a protocol data unit (PDU) of a PDU session or a PDU of a multicast-broadcast service (MBS) session associated with a PDU Session User Plane Protocol; the packet includes a header; and the header includes the marking.

Example 4 includes the method of any of examples 1-3 or some other examples herein, further including: configuring a data radio bearer (DRB) for downlink transmissions; and mapping the packet to the DRB based on the marking.

Example 5 includes the method of any of examples 1-4 or some other examples herein, wherein: the marking is in an information element associated with a transfer of the packet over an N3 interface; and the information element is a downlink packet data unit (PDU) session information format.

Example 6 includes the method of any of examples 1-5 or some other examples herein, wherein the packet is a downlink packet, and the cumulative processing or the LIFO processing includes: adding the packet to a queue before a sequence number is assigned to the packet; processing a forwarding packet from the queue; and receiving a consent; flushing one or more superfluous packets of the queue based on the consent.

Example 7 includes the method of any of examples 1-6 or some other examples herein, wherein the packet is a downlink packet, and the cumulative processing or the LIFO processing includes: configuring a timer; adding the downlink packet to a queue; selecting a forwarding packet from the queue; transmitting the forwarding packet; and flushing the queue based on the timer.

Example 8 includes the method of any of examples 1-7 or some other examples herein, wherein the packet is a downlink packet, and the cumulative processing or the LIFO processing includes: configuring a packet detection rule (PDR); adding the downlink packet to a queue based on the marking and the PDR; selecting a forwarding packet from the queue; transmitting the forwarding packet; and flushing the queue based on the PDR.

Example 9 includes the method of any of examples 1-8 or some other examples herein, wherein the cumulative processing or the LIFO processing includes: configuring a packet filter; and adding the packet to a queue based on the packet filter.

Example 10 includes the method of any of examples 1-9 or some other examples herein, wherein the packet filter is a traffic control protocol (TCP)-control-flags filter, a cumulative-mode-condition filter, or a payload-condition filter.

Example 11 includes the method of any of examples 1-10 or some other examples herein, wherein: the NE is a user plane function (UPF); the marking is in an information element associated with a transfer of the packet over an N3 interface; and the information element is an uplink packet data unit (PDU) session information format.

Example 12 includes a method of operating a network element (NE), the method including: receiving a configuration; associating, based on the configuration, a cumulative mode (CM) configuration with a quality of service (QoS) flow, a radio link control (RLC) entity, or a data radio bearer (DRB); receiving a packet associated with the QoS flow, the RLC entity, or the DRB, the packet ; and performing a CM processing or a LIFO processing on the packet based on the CM configuration.

Example 13 includes the method of example 12 or some other examples herein, wherein the NE is a base station (BS), a user plane function (UPF), or a user equipment (UE).

Example 14 includes the method of examples 12 or 13 or some other examples herein, further including: receiving one or more control messages to configure the NE with the LIFO processing or a discard timer.

Example 15 includes the method of any of examples 12-14 or some other examples herein, wherein: the NE is a base station; the configuration is a message from an access and mobility management function (AMF) transferred over an N2 interface; the message includes an information element associated with the QoS flow; and the information element includes a QoS CM indication or a cumulative delivery attribute.

Example 16 includes the method of any of examples 12-15 or some other examples herein, wherein the packet is a downlink packet, and the cumulative processing or the LIFO processing includes: adding the packet to a queue before a sequence number is assigned to the packet; processing a forwarding packet from the queue; and flushing one or more superfluous packets of the queue.

Example 17 includes the method of any of examples 12-16 or some other examples herein, wherein the packet is a downlink packet, and the cumulative processing or the LIFO processing includes: configuring a timer; adding the downlink packet to a queue; selecting a forwarding packet from the queue; transmitting the forwarding packet; and flushing one or more superfluous packets of the queue based on the timer.

Example 18 includes the method of any of examples 12-17 or some other examples herein, wherein the packet is a downlink packet, and the cumulative processing or the LIFO processing includes: configuring a packet detection rule (PDR); adding the downlink packet to a queue based on the PDR; selecting a forwarding packet from the queue; transmitting the forwarding packet; and flushing the queue based on the PDR.

Example 19 includes the method of any of examples 12-18 or some other examples herein, wherein the cumulative processing or the LIFO processing includes: configuring a packet filter; and adding the packet to a queue based on the packet filter.

Example 20 includes the method of any of examples 12-19 or some other examples herein, wherein the packet filter is a traffic control protocol (TCP)-control-flags filter, a cumulative-mode-condition filter, or a payload-condition filter.

Example 21 includes the method of any of examples 12-20 or some other examples herein, wherein: the NE is a user plane function (UPF); the marking is in an information element associated with a transfer of the packet over an N3 interface; and the information element is an uplink packet data unit (PDU) session information format.

Example 22 includes the method of any of examples 12-21 or some other examples herein, wherein the NE is a user equipment (UE); the configuration is a message from an access and mobility management function (AMF) transferred over an N1 interface or a radio resource control (RRC) signaling; the message includes an information element associated with the QoS flow, the DRB, or the RLC entity; and the information element includes a QoS CM indication or a cumulative delivery attribute.

Example 23 includes the method of any of examples 12-22 or some other examples herein, wherein the NE is a user equipment (UE), the packet is a packet data convergence protocol (PDCP) serving data unit (SDU) or a service data adaptation protocol (SDAP) SDU, and the cumulative processing or the LIFO processing includes: configuring a discard timer; adding the SDU to a queue; selecting a forwarding packet from the queue; transmitting the forwarding packet; and flushing the queue based on the discard timer.

Example 24 includes the method of any of examples 12-23 or some other examples herein, wherein the NE is a user equipment (UE) and the method further includes: transmitting an indication that the UE supports CM processing or LIFO processing for a layer, data radio bearer, quality of service flow, Internet protocol flow, service data flow, or protocol data unit set.

Example 25 includes a method of operating a base station (BS), the method including: receiving, from a user equipment (UE), a UE assistance information (UAI); determining whether to configure a per-flow or a per-packet cumulative mode (CM) processing based on the UAI; and configuring a per-flow or a per-packet CM processing based on the UAI.

Example 26 includes the method of example 25 or some other examples herein, wherein the UAI includes an indication to activate or deactivate the CM processing.

Example 27 includes the method of examples 25 or 26 or some other examples herein, wherein the UAI includes an indication of applying a per-flow or per-packet CM processing to one or more data radio bearers (DRBs), radio link control (RLC) entities, quality of service (QoS) flows, or protocol data unit (PDU) set types.

Another example may include an apparatus comprising logic, modules, or circuitry to perform one or more elements of a method described in or related to any of examples 1-27, or any other method or process described herein.

Another example may include a method, technique, or process as described in or related to any of examples 1-27, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-27, or portions thereof.

Another example includes a signal as described in or related to any of examples 1-27, or portions or parts thereof.

Another example may include a datagram, information element, packet, frame, segment, PDU, or message as described in or related to any of examples 1-27, or portions or parts thereof, or otherwise described in the present disclosure.

Another example may include a signal encoded with data as described in or related to any of examples 1-27, or portions or parts thereof, or otherwise described in the present disclosure.

Another example may include a signal encoded with a datagram, IE, packet, frame, segment, PDU, or message as described in or related to any of examples 1-27, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-27, or portions thereof.

Another example may include a computer program comprising instructions, wherein execution of the program by a processing element is to cause the processing element to carry out the method, techniques, or process as described in or related to any of examples 1-27, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-27. (canceled)

28. A method comprising:
receiving a configuration associated with a cumulative processing or a last-in-first-out (LIFO) processing;
receiving a packet including a marking to indicate to perform the cumulative processing or the LIFO processing on the packet; and
performing the cumulative processing or the LIFO processing based on the marking and the configuration.

29. The method of claim 28, wherein:
the packet is a general packet radio service (GPRS) tunneling protocol user plane (GTP-U) packet, a next-generation (NG) user-plane interface (NG-U) packet, a protocol data unit (PDU) of a PDU session or a PDU of a multicast-broadcast service (MBS) session associated with a PDU Session User Plane Protocol;
the packet includes a header; and
the header includes the marking.

30. The method of claim 28, further comprising:
configuring a data radio bearer (DRB) for downlink transmissions; and
mapping the packet to the DRB based on the marking.

31. The method of claim 28, wherein:
the marking is in an information element associated with a transfer of the packet over an N3 interface; and
the information element is a downlink packet data unit (PDU) session information format.

32. The method of claim 28, wherein the packet is a downlink packet, and the cumulative processing or the LIFO processing comprises:
adding the packet to a queue before a sequence number is assigned to the packet;
processing a forwarding packet from the queue; and
receiving a consent;
flushing one or more superfluous packets of the queue based on the consent.

33. The method of claim 28, wherein the packet is a downlink packet, and the cumulative processing or the LIFO processing comprises:
configuring a timer;
adding the downlink packet to a queue;
selecting a forwarding packet from the queue;
transmitting the forwarding packet; and
flushing at least one packet of the queue based on the timer.

34. The method of claim 28, wherein the packet is a downlink packet, and the cumulative processing or the LIFO processing comprises:
configuring a packet detection rule (PDR);
adding the downlink packet to a queue based on the marking and the PDR;
selecting a forwarding packet from the queue;
transmitting the forwarding packet; and
flushing at least one packet of the queue based on the PDR.

35. The method of claim 28, wherein the cumulative processing or the LIFO processing comprises:
configuring a packet filter, wherein the packet filter is a traffic control protocol (TCP)-control-flags filter, a cumulative-mode-condition filter, or a payload-condition filter; and
adding the packet to a queue based on the packet filter.

36. The method of claim 28, wherein:
the marking is in an information element associated with a transfer of the packet over an N3 interface; and
the information element is an uplink packet data unit (PDU) session information format.

37. An apparatus comprising:
processing circuitry to:
receive a configuration;
associate, based on the configuration, a cumulative mode (CM) configuration with a quality of service (QoS) flow, a radio link control (RLC) entity, or a data radio bearer (DRB);
receive a packet associated with the QoS flow, the RLC entity, or the DRB; and
perform a CM processing or a LIFO processing on the packet based on the CM configuration; and
interface circuitry coupled to the processing circuitry to receive the configuration.

38. The apparatus of claim 37, wherein the processing circuitry is further to:
receive one or more control messages to configure a network element (NE) with the LIFO processing or a discard timer.

39. The apparatus of claim 37, wherein:
the configuration is a message from an access and mobility management function (AMF) transferred over an N2 interface;
the message includes an information element associated with the QoS flow; and
the information element includes a QoS CM indication or a cumulative delivery attribute.

40. The apparatus of claim 37, wherein the packet is a downlink packet, and the cumulative processing or the LIFO processing comprises:
adding the packet to a queue before a sequence number is assigned to the packet, processing a forwarding packet from the queue, and flushing one or more superfluous packets of the queue; or
configuring a timer, adding the downlink packet to a queue, selecting a forwarding packet from the queue, outputting the forwarding packet for transmission, and flushing one or more superfluous packets of the queue based on the timer; or
configuring a packet detection rule (PDR), adding the downlink packet to a queue based on the PDR, selecting a forwarding packet from the queue, outputting the forwarding packet for transmission, and flushing the queue based on the PDR.

41. The apparatus of claim 37, wherein the cumulative processing or the LIFO processing comprises:
configuring a packet filter, wherein the packet filter is a traffic control protocol (TCP)-control-flags filter, a cumulative-mode-condition filter, or a payload-condition filter; and
adding the packet to a queue based on the packet filter.

42. The apparatus of claim 37, wherein the configuration is a message from an access and mobility management function (AMF) transferred over an N1 interface or a radio resource control (RRC) signaling;
the message includes an information element associated with the QoS flow, the DRB, or the RLC entity; and
the information element includes a QoS CM indication or a cumulative delivery attribute.

43. The apparatus of claim 37, wherein the packet is a packet data convergence protocol (PDCP) serving data unit (SDU) or a service data adaptation protocol (SDAP) SDU, and the cumulative processing or the LIFO processing comprises:
configuring a discard timer;
adding the SDU to a queue;
selecting a forwarding packet from the queue;
outputting the forwarding packet for transmission; and
flushing at least one packet of the queue based on the discard timer.

44. The apparatus of claim 37, wherein the processing circuitry is further to:
generate, for transmission to a network, an indication that a user equipment (UE) supports CM processing or LIFO processing for a layer, data radio bearer, quality of service flow, Internet protocol flow, service data flow, or protocol data unit set.

45. A method comprising:
receiving, from a user equipment (UE), a UE assistance information (UAI);
determining whether to configure a per-flow or a per-packet cumulative mode (CM) processing based on the UAI; and
configuring a per-flow or a per-packet CM processing based on the UAI.

46. The method of claim 45, wherein the UAI includes an indication to activate or deactivate the CM processing.

47. The method of claim 45, wherein the UAI includes an indication of applying a per-flow or per-packet CM processing to one or more data radio bearers (DRBs), radio link control (RLC) entities, quality of service (QoS) flows, or protocol data unit (PDU) set types.
